(19) United States
(12) Patent Application Publication
(10) Pub. No.: US 2016/0203572 A1
(43) Pub. Date: Jul. 14, 2016

(54) METHOD TO SECURELY ESTABLISH, AFFIRM, AND TRANSFER OWNERSHIP OF ARTWORKS

(71) Applicant: ASCRIBE GMBH, Berlin (DE)

(72) Inventors: Trent Lorne MCCONAGHY, Berlin (DE); Maria MCCONAGHY, Berlin (DE)

(73) Assignee: Ascribe GMBH, Berlin (DE)

(21) Appl. No.: 14/913,344

(22) PCT Filed: Aug. 21, 2014
(86) PCT No.: PCT/CA2014/050805

§ 371 Date: Feb. 19, 2016

Related U.S. Application Data
(60) Provisional application No. 61/868,256, filed on Aug. 21, 2013.

(51) Int. Cl. G06Q 50/18; G06Q 20/38; G06Q 20/10; G06Q 20/12; G06F 21/16; G06Q 20/06

(52) U.S. Cl. CPC G06Q 50/184; G06F 21/16; G06Q 20/065; G06Q 20/10; G06Q 20/1235; G06Q 20/38215; G06Q 20/3827; G06Q 20/3829; G06F 2221/0724

(57) ABSTRACT

A method for establishing, confirming, and transferring ownership of digital artworks. The method associates a given artwork to a unique public ID and to an online service. The owner of the artwork is the person who has full access to the online service at the public ID. Confirming ownership of the artwork includes the owner performing an action that demonstrates the owner has full access to the online service at the public ID. Transferring ownership of the artwork includes (1) transferring access to the account itself, or (2) using the online service's transfer protocol, which may also update the public ID associated with the owner of the artwork.

### FIELD

The present disclosure relates generally to artworks created by artists, and the process of establishing ownership, affirming ownership, and transferring ownership of such artworks. More particularly, the present disclosure relates to artworks that are easily reproducible such as digitally-based artworks.

### BACKGROUND

Artists and designers create artworks. These may be sculptures, paintings, photographs, digitally created images, videos, etc. These artworks are often sold to people or organizations, such as art collectors or museums. Sometimes agents work on behalf of the artists in the sales process, such as art galleries.

Some artworks are reproducible, which is to be understood as meaning that the artworks can be reproduced by some means such that a copy is indistinguishable, or substantially indistinguishable, from the original.

Such “reproducible” artwork includes digital media, which is easy to reproduce using modern digital computers. For example, copies of a digital image artwork are indistinguishable from the original digital image artwork. As a second example, copies of digital video artworks are also indistinguishable from the original.

But “reproducible” artworks do not include solely digital media. In one example, the artwork might be a sculpture that is 3d-printed (i.e., printed in three dimensions). It may be possible to reproduce the sculpture by performing a 3d scan of the piece, then printing it out in 3d (three dimensions). A traditional bronze sculpture is another example; if one has access to the original cast, then one is able to make multiple copies of the sculpture. In a third example, one could perform a 3d scan of a bronze sculpture, then create a new cast from that scan, and finally make multiple copies from the new cast. In a fourth example, a highly skilled painter may be able to reproduce a painting so exactly that the reproduction is indistinguishable from the original.

The idea of owning an artwork is important to an art collector, who may spend thousands or even millions of dollars on artworks. If the art collector cannot establish ownership, confirm ownership, or transfer ownership of an artwork, then it is difficult to justify spending the money on the artwork. This idea of owning an artwork is also important to an artist: once they have created the artwork, the artist wants it to be easy to tell that they were the creator, and especially that it is easy for people to buy and own the artist's created artworks. This idea of “owning” is also important to an agent of an artist, such as a gallerist, who acts on the artist's behalf in selling the artist's work to a collector.

Traditionally, it has been usually relatively easy to establish, confirm, and transfer ownership of an artwork, because the pieces were difficult to reproduce in a way that the reproduction was (near) indistinguishable from the original. Consider, for example, Leonardo Da Vinci's Mona Lisa painting. To reproduce it would require getting a canvas that is hundreds of years old, with exactly the same material composition as the original canvas; getting paint that is hundreds of years old, with exactly the same material composition as the original paint; and to paint the image on the canvas so that it looks exactly the same, down to the last brush stroke. It was easy to establish that Da Vinci created the Mona Lisa because many people observed him painting it in his work space. It is easy to affirm ownership and transfer ownership, because it is a physical object that is extremely difficult to reproduce; therefore ownership is related to its physical location. In the case of the Mona Lisa, it is physically located in the Louvre, Paris and owned by the French government. Traditionally, “owning” an artwork meant owning the actual physical copy.

However, this idea of ownership presents a problem in the case of “reproducible” artwork, because reproductions of the original artwork are (near) indistinguishable from the original artwork. Others may reproduce the art fairly accurately, which then makes the ownership ambiguous. First, there is little or no mechanism to establish where the original piece came from. Second, there is little or no mechanism to verify who the true owner is. Third, there is little or no mechanism to transfer ownership of the “real” piece.

For example, consider a digital image artwork that one might find on a web page on the Internet. First, it does not give where it originally came from. Even if it had a signature style marking in a corner, that could have been illegitimately put onto a copy. Second, if person A owns this artwork, where is the proof? They might have just simply copied it from elsewhere and claimed it as their own. Third, if person B legitimately owns the piece and sells it to person C, what happens if afterwards person B still claims to be the owner?

Because ownership of a reproducible artwork is so ambiguous, this hurts the value of the art. Someone may copy the original artwork, and claim ownership of the “true” artwork. This hurts the ability to sell “reproducible” art. Specifically, potential buyers of “reproducible” art are reluctant to spend money on the art when it is so readily susceptible to being copied. If the art collector cannot establish ownership, confirm ownership, or transfer ownership of an artwork, then it is difficult to justify spending thousands or millions of dollars on the artwork.

There is a history of attempts to fix this issue, going back centuries. The first example is in traditional bronze sculptures. Here, the original cast is kept, closely guarded, by the artist (or artist agents) and new copies released as legitimate, numbered “prints”. Only a handful, say 3-10, “prints” are done. The second example is similar to the first, but for etchings. The original etching block is kept by the artist. The third example is similar to the first, but for film-based photographic art. The photograph's negatives are kept by the artist.

The general approach behind these “fixes” has been to keep the original cast/block/negative closely guarded by the artist (or artist agent).

However, as described above, new technologies like 3d scanning and printing make it easier to reproduce traditional artworks (sculptures, etchings, photographic art), which gives them higher risk exposure than they traditionally had.

Even worse, this general approach does not work for new digital-based media where reproduction is trivial, by simply copying the digital work (digital image, digital video) bit by bit. Copying of these digital bits is lossless, resulting in perfect copies.

To summarize, traditional approaches to establish, affirm, and transfer true ownership of “reproducible” artworks have major flaws. These flaws hinder the ability to sell digital media-based artworks, and even some traditional art media are exposed to new risks.

Therefore, improvements in assigning, affirming, and transferring ownership among reproducible artworks are desirable.

### SUMMARY

The aim of this disclosure is to overcome these issues, with a trustworthy approach to establish ownership, affirm ownership, and transfer ownership of “reproducible” artworks. It applies especially to digital media artworks.

The disclosure is summarized as follows. The main idea is to establish ownership by associating a given artwork with unique ID for an online service, such as, for example, the username on Gmail™ (Google's free web-based email service at http://www.gmail.com), or a Bitcoin address on the Bitcoin network (see http://www.bitcoin.org), or in any other suitable manner. The owner of the artwork is defined as the person who has full access to the online service at that ID; for example can send and receive email from that Gmail™ account, or can send bitcoins from the specified Bitcoin address. An owner of an artwork can affirm ownership by performing an action which demonstrates that they have said full access, such as sending and receiving email from the specified Gmail™ address, or sending bitcoins from the specified Bitcoin address. Ownership of the artwork may be transferred depending on the nature of the online service, in a number of ways. For example: (1) transferring access to the account itself; for example in Gmail™, giving the username and password to the new owner, who would likely change the password immediately, or (2) by using the online service's transfer protocol; for example in Bitcoin, transferring funds from the previous Bitcoin address to a Bitcoin address B owned by the new owner; defining the owner of address B as the owner of the artwork.

In short, the owner of the public ID (account) on the designated online service is, by definition, the owner of the artwork. Therefore a single owner is possible. The key is that ownership on that online service can be managed in a trustworthy fashion, so by extension the artwork associated with the (online service, account on the online service) also has its ownership managed in a trustworthy fashion. This enables secure “single owner” means to establish ownership, affirm ownership, and transfer ownership of “reproducible” artworks.

As another benefit, the present disclosure provides a desirable level of anonymity and ownership: collectors can remain anonymous if they choose, and when they wish to demonstrate that they own a piece, they only need to demonstrate to interested parties that they can control the public ID associated with the artwork.

Extra benefits may arise, depending on the nature of the service. For example with Gmail™, extra security may be gained via two-factor authentication, and lost passwords may be handled using the usual lost-password process for Gmail™ users. For example with Bitcoin, if the original Bitcoin address associated with the artwork is made publicly available, since all Bitcoin transactions are publicly available via the Bitcoin blockchain, which is a secure master list or ledger (electronic ledger) of all Bitcoin transactions, then the Bitcoin address currently associated with the artwork can always be determined.

This disclosure has variants that extend beyond reproducible artworks. We describe those variants in the detailed description.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 shows a flowchart of a method in accordance with the present disclosure.

FIG. 2 shows an embodiment of the method of FIG. 1 that leverages the existing technology and computing infrastructure of Gmail™.

FIG. 3 shows an embodiment of the method of FIG. 1 that leverages the existing technology and computing infrastructure of Bitcoin.

FIG. 4 shows another embodiment of a method of the present disclosure that leverages the existing technology and computing infrastructure of Bitcoin.

### DETAILED DESCRIPTION

Generally, the present disclosure provides a method to establish, affirm, and transfer ownership of “reproducible” artwork, including digital media artwork.

For the purpose of the present disclosure the expression “account” with respect to an online service can mean a unique public identifier at the online service or a unique public address at the online service. Also for the purpose of the present disclosure, the expression “marking an artwork” includes placing an inscription on the artwork, placing a QR code on the artwork, and placing a watermark (either clearly visible watermark or a hidden watermark) on the artwork.

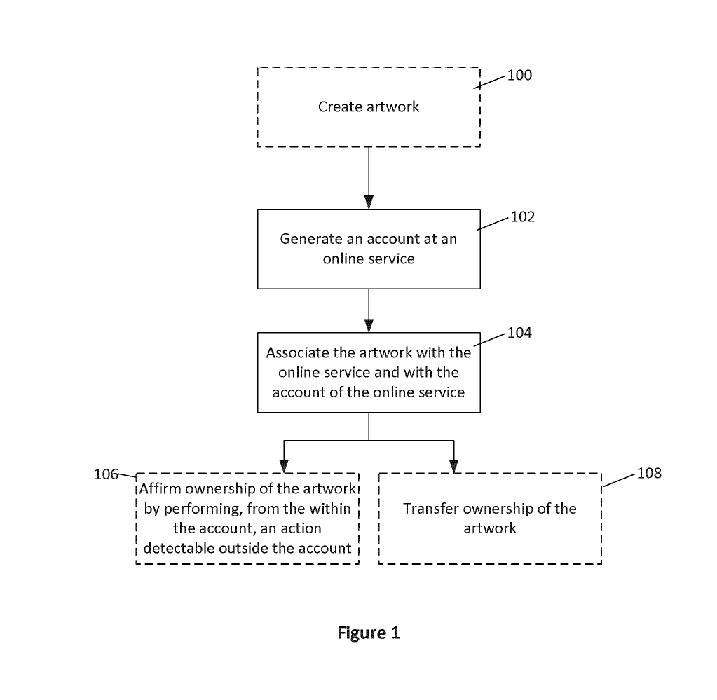

FIG. 1 shows the general flow of a method of the present disclosure. As will be described in detail below, the flow of FIG. 1 addresses the issues described in prior art approaches.

In detail, the flow of FIG. 1 is as follows. At action 100, the artist creates a new artwork, which may be reproducible. Alternatively, the artwork need not have been created by the artist. That is, the artist could have acquired the artwork in any suitable way; for example, the digital artwork could have been gifted to the artist.

At action 102, an account at an online service is generated. At action 104, the artwork gets associated with the account (unique public ID) at an online service, and with the online service itself. The online service and the account of the online service (online service, account of the online service) can come in various forms. The specific embodiments described below give two very particular forms: (Gmail™, username) and (bitcoin network, bitcoin address). There is a huge set of possible online services, such as, for example, Twitter′, Facebook™, LinkedIn™, Yahoo Mail™, Litecoin, and Ethereum.

The common thread among these online services is that they are designed for only one person/entity to have full access to the associated public ID (account), and enjoy the benefits of full access associated with that public ID. As an example, Gmail™ is designed so that only one person can access the username johndoe by entering their username and password at the gmail.com login, and therefore there is only one person who can receive emails addressed to johndoe@gmail.com. The bitcoin protocol is designed so that only the person who has the private key associated with a given bitcoin address can send funds from that bitcoin address. Put another way, there is only one “owner” for a given (online service, public ID), which can also be referred to as (online service, account at the online service). Two elements presented in parentheses and separated by a comma can be referred to as a pair of elements or a two-element tuple. The password used in the Gmail™ example and the private key used in the bitcoin example can be referred to generally as passcodes. Passcodes can include other authentication factors such as, for example, a personal identification number, a computer-readable pattern, a biometric factor (fingerprints, retinal image), etc. The owner or keeper of the passcode is the owner of the artwork.

However, there may be partial access for a given (online service, public ID) to the public at large. For example, anyone can send an email to johndoe@gmail.com, and anyone can send bitcoins to a given bitcoin address.

The association between artwork and (online service, public ID) may happen in many ways. For example, the artist (or artist agent) might place a watermark of the (online service, public ID) inside the piece such that the (online service, public ID) is not obvious to the casual observer, yet it exists. As another example, the artist may write or inscribe the (online service, public ID) in a legible fashion in a corner of the artwork (if an image), such as by writing art_work_0123@gmail.com in the bottom right corner. In yet another example, the artist may post the artwork image plus the (online service name, public ID) onto his Internet homepage, or as a post on a social media platform like Facebook™ or Twitter™, or onto a website dedicated to listing many artists' artwork/(online service, public ID) pairs. This is not an exhaustive list; there are plenty of other suitable ways to associate an artwork to a (online service, public ID).

At action 104, the owner of the passcode for the account at the online service is, by definition, the owner of the artwork. This is an important tenet of the present disclosure. As the passcode of the account at that online service can be managed in a trustworthy fashion, so by extension the artwork associated with the (online service, public ID) also has its ownership managed in a trustworthy fashion.

Action 106 is to confirm (affirm) ownership of the artwork. It may happen 0, 1, 2, or any number of times in the lifetime of the artwork. The key idea to confirm ownership of the artwork is to confirm ownership of the (online service, account at the online service) by performing an action, from within the account that only the owner of the account and passcode can perform and that is detectable outside the account. For example, if person B wants to confirm that person A owns the artwork associated with the account art_work_0123@gmail.com, person B could send an email to art_work_0123@gmail.com, person A would log into their account for art_work_0123 at gmail.com, see the email from person B, and respond to person B with an email from art_work_0123@gmail.com. Sending the email from within the account is detectable outside the account by person B. In another example using the blogging service Twitter′, where an artwork is associated with the handle @art_work_0123, person A could send a tweet from @art_work_0123 with text that acknowledges a person's (e.g., person B) query, such as “Person B, this one's for you.” Sending the tweet from within the account is detectable outside the account by everyone who has access to Twitter™. This is not an exhaustive list; there are plenty of other conceivable and suitable ways to confirm ownership of an account at an online service, and therefore to confirm ownership of the artwork. Any action that can confirm (affirm) ownership of the artwork can be referred to as a confirmation action or as an affirmation action.

Action 108 relates to transferring ownership of the artwork. It may happen 0, 1, 2, or any number of times in the lifetime of the artwork. Transfer may happen several ways.

In some embodiments, transfer of the ownership of an artwork can be effected by transferring “full access” control (full control) of the account at the online service to which the artwork is associated. As an example, which is further described below, an artwork associated with a Gmail™ account can be transferred to a person by transferring control of Gmail™ account to the person in question. This entails providing the passcode of the Gmail™ account to the person who can immediately modify the passcode.

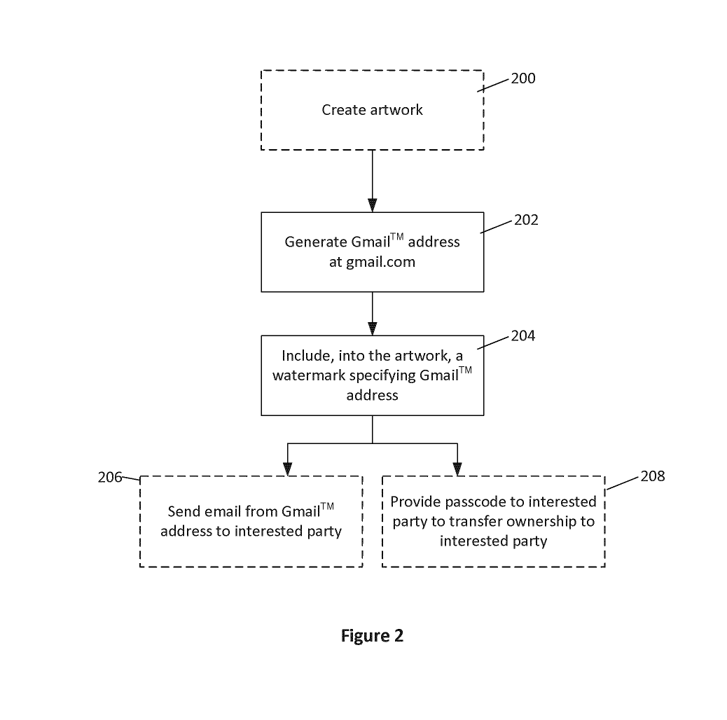

FIG. 2 shows a flowchart of a specific embodiment of the disclosure that leverages the existing technology and computing infrastructure of Gmail™, the free web-based email service provided by Google Inc. at http:://www.gmail.com.

At action 200, an artwork (e.g., an image) is created. Alternatively, the digital artwork need not have been created by the artist. That is, the artist could have acquired the digital artwork in any suitable way; for example, the digital artwork could have been gifted to the artist.

At action 202, the artist goes to http:://www.gmail.com and creates (generates) a new account. This includes specifying a username (account) and a password (passcode), which result in an email address. For example, the username may be artwork_1234, and the email address may be artwork_1234@gmail.com.

At action 204, the artist associates the artwork with the new Gmail™ account by putting (including), for example, a visible or a hidden watermark of “artwork_1234@gmail.com” into the image. This watermark is not obvious to the casual observer. The artist can also simply inscribe the artwork with the plainly legible text artwork_1234@gmail.com. The owner of the Gmail account at that username is, by definition, the owner of the artwork. In our example, the artist is the owner because he owns and controls the “artwork_1234” account at Gmail™. He is the only one that can send and receive email with the address artwork_1234@gmail.com. Since ownership of that Gmail™ account can be managed in a trustworthy fashion, by extension the artwork associated with that Gmail™ account also has its ownership managed in a trustworthy fashion.

Action 206 confirms (affirms) ownership of the artwork. It may happen 0, 1, 2, or any number of times in the lifetime of the artwork. In this implementation, if person B wants to confirm that person A owns the artwork associated with an account (say art_work_0123@gmail.com), then person B (an interested party) can send an email to art_work_0123@gmail.com, person A would log into their account for art_work_0123 at gmail.com, see the email sent from person B, and respond to person B with an email from art_work_0123@gmail.com. Sending an email from the account of person A to the account of person B can be referred to as a confirmation action or as an affirmation action.

Action 208 relates to transferring ownership of the artwork. It may happen 0, 1, 2, or any number of times in the lifetime of the artwork. In the present example, person A transfers ownership to person B. First, person A ensures that the Gmail™ two-factor authentication is off, so that only a single password (passcode) is needed to access the Gmail account. Then, person A simply gives person B the username and password. Person B immediately logs in and changes the password, to prevent person A from accessing the account in the future. This guarantees that person B is the sole person with full control of the account. Because person B is the sole person with full control of the account, by definition he is the owner of the artwork.

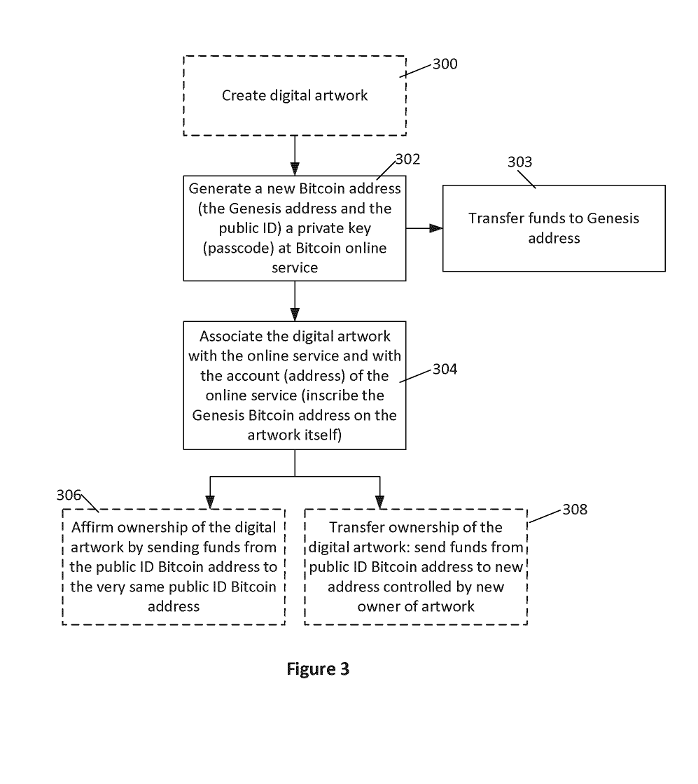

FIG. 3 shows a flowchart of a specific embodiment of the disclosure that leverages the existing technology and computing infrastructure of Bitcoin, including electronic Bitcoin-based transfer of ownership.

A Bitcoin address is an identifier of 27-34 alphanumeric characters, beginning with the number 1 or 3. An example Bitcoin address is 31 uEbMgunupShBVTewXjtqbBv5MndwfXhb.

As will be described below, in the example of FIG. 3, the public ID for the artwork is the bitcoin address associated with the current owner. If we know the Bitcoin address of the original owner of the artwork (the “Genesis” bitcoin address) then we can simply follow the chain of bitcoin transactions to compute the bitcoin address of the current owner (that is, the public ID for the artwork). To be clear, after the first sale, the public ID for the artwork is not the Genesis address.

At action 300, the artist creates a digital artwork. Alternatively, the digital artwork need not have been created by the artist. That is, the artist could have acquired the digital artwork in any suitable way; for example, the digital artwork could have been gifted to the artist.

At action 302, the artist or his agent creates a new Bitcoin address, which is both the Genesis address and the first public identifier for the artwork, and private key (passcode). This is effected by making a request from the public Bitcoin API to generate this key pair. At action 303, the artist or his agent transfers 1.0000 bitcoin (or any other suitable amount) into the new Bitcoin address (which can also be referred to as a Bitcoin account). If the agent obtained the private key and the public key, the agent can give the key pair to the artist, and deletes his copy of the private key.

At action 304, the artist makes an association between the artwork and the Bitcoin public key (address), by inscribing the Genesis address on the artwork in any suitable way such as by, for example, watermarking the artwork with the Genesis address, writing the Genesis address on the artwork, creating a QR code of the Genesis address and displaying the QR code on the artwork, etc. The Genesis address is also the public identifier (ID), which can be referred to as the public key or as the public address, of the artwork as long as ownership of the artwork is not transferred to another address. When ownership of the artwork is transferred to another address, the public ID of the artwork is now this other address, which can be determined by consulting the blockchain, which will show a transaction from the Genesis address to the other address. For example, if the artwork is created by person A, person A obtains a Bitcoin address, address A, and marks the artwork with address A. At this stage, the address is the Genesis address and the public ID of the artwork. Transferring ownership of the artwork to person B entails transferring funds to the address of person B. After this transfer of ownership, the artwork's Genesis address remains the same, i.e., address A but, the public address of the artwork is now address B. This is ascertained by verifying the blockchain which shows a transfer of funds between address A and address B. If a subsequent transfer of ownership is effected, for example to person C who has address C, the Genesis address of the artwork remains the same, i.e., address A but, the public address of the artwork is now address C.

Inscribing the Genesis address on the artwork changes/transforms the artwork into an inscribed artwork or a transformed artwork.

The owner of the Bitcoin address associated with the artwork (i.e., the owner of the public ID) is, by definition, the owner of the artwork. In this example, the artist starts out as the owner because he owns and controls the Bitcoin address (the Genesis address) currently associated with the artwork. That is, the artist has transferred ownership of the artwork to another address. He is the only one that can send and receive Bitcoin cryptocurrency using the aforementioned keys. As ownership of that Bitcoin account can be managed in a trustworthy fashion, by extension the artwork associated with the Bitcoin account also has its ownership managed in a trustworthy fashion.

Action 306 confirms (affirms) ownership of the artwork. It may happen 0, 1, 2, or any number of times in the lifetime of the artwork. If person B wants to confirm that person A owns the artwork, person B can request that person A prove ownership of the artwork by sending funds to its own account (person's A account), which would be recorded in the blockchain and would be publicly available for person B to see. That is, upon request from person B, person A could transfer 0.0001 bitcoin from the public ID of the artwork to the very same public ID of the network and person B would know that the transaction took place by consulting the blockchain. Alternatively, if person B wants to confirm that person A owns the artwork associated with the Bitcoin address, person A could send 0.0001 bitcoins (or any other amount of bitcoins) from the associated Bitcoin address to a Bitcoin address controlled by person B. Person B is now satisfied that person A owns the account. To keep the balance even between person A and person B, person B returns the 0.0001 bitcoins back to the person A's Bitcoin address (account). Any action that can confirm (affirm) ownership of the artwork can be referred to as a confirmation action or as an affirmation action.

Action 308 transfers ownership of the artwork using a Bitcoin protocol over the Bitcoin network. It may happen 0, 1, 2, or any number of times in the lifetime of the artwork. Let us consider person A transferring ownership of an artwork to person B. Therefore, person A controls the Bitcoin address currently associated with the artwork, call it address A, which, is the Genesis address for as long as the ownership of the artwork is not transferred to another address. Person B first creates a new Bitcoin public key (address) and a private key, call it address B. Person B gives the address B to person A. Alternatively, a third party can leverage the Bitcoin protocol to generate an address B and provide address B to person A (the passcode of address B is not provided to person A); the third party also provides address B and the passcode of address B to person B. In other embodiments, person A can play the role of the third party. Person A then uses Bitcoin's secure transfer mechanism to transfer all bitcoins from address A to address B. By definition, the owner of address B is the owner of the artwork. Therefore, person B is the owner of the artwork. In an alternative embodiment, ownership transfer is defined when the first funds move from address A to any new address B. After that, other transactions on address A do not affect ownership (except when the first funds leaving address A go back to address B). In another alternative embodiment, ownership transfer only happens the first time a pre-specified amount of funds move from address A to address B. There are many other conceivable embodiments.

The transfer leverages Bitcoin's secure transfer protocol. The Bitcoin network has a secure master list of all Bitcoin transactions, called the “blockchain”. It is secure in that it can only be changed in a trusted fashion. In the Bitcoin paradigm, this means: have many master ledgers distributed across computers all over the internet that are run by at least partly independent organizations. Any proposed transfer only goes through if there is sufficient agreement among the (machines of the) ledger owners. The blockchain is public. Given that the original Bitcoin address (the Genesis address) of the artwork is written on the artwork (in this example), then the Bitcoin address of the current owner can be computed (determined) by reviewing the chain of transactions on the blockchain.

In another embodiment related to Bitcoin, and discussed below, transfer of ownership can be effected by creating a physical artifact that includes the Bitcoin public key (account), as well as the related private key (passcode) needed to send funds from that account. To effect transfer of ownership, the previous owner gives the new owner the physical artifact associated with the artwork.

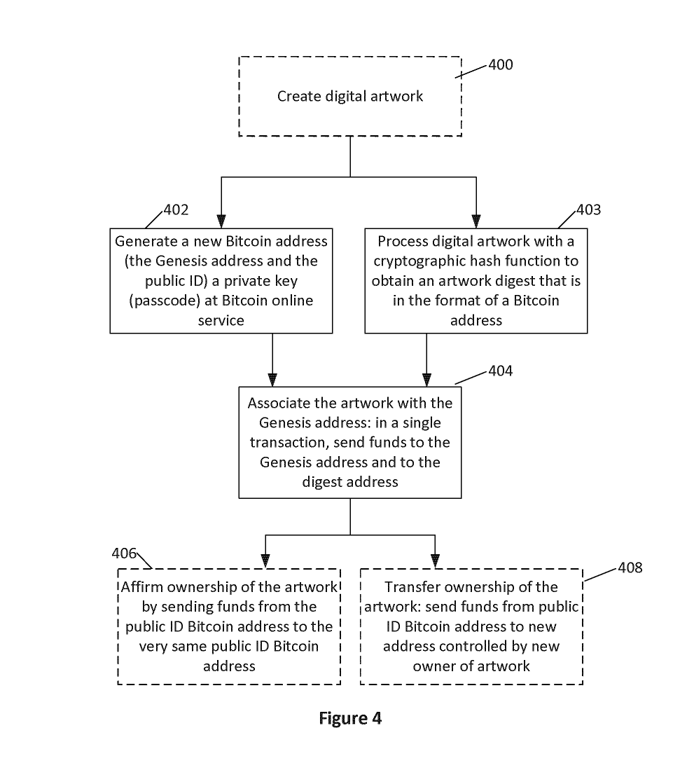

FIG. 4 shows a flowchart of another embodiment of the disclosure that also leverages the existing technology and computing infrastructure of Bitcoin, including electronic bitcoin-based transfer of ownership. The embodiment of FIG. 4 creates a single transaction that includes both a hash of the artwork and the address itself. At action 400, a digital artwork is created. Alternatively, the digital artwork need not have been created by the artist. That is, the artist could have acquired the digital artwork in any suitable way; for example, the digital artwork could have been gifted to the artist.

At action 402, the artist or his agent creates a new Bitcoin public key (account) and private key (passcode). This is effected by making a request from the public Bitcoin API to generate this key pair. This address is the first address (first account) associated with the artwork and can be referred to as the Genesis address.

At action 403, the digital artwork is processed by a cryptographic hash function to produce a digest (artwork digest) that is in the form of a Bitcoin address (an identifier of 27-34 alphanumeric characters, beginning with the number 1 or 3) and that constitutes an artwork digest address. The risk of having the artwork digest artwork address match an existing Bitcoin address is extremely small. For example in a Bitcoin address, for each character of the address, there are available at least all lowercase letters, all uppercase letters, and digits, therefore at least 26+26+10=62 possible values per character slot. In a 20 character string, then the chance of one address overlapping another is less than 1/62²⁰. Any suitable cryptographic hash function can be used. For example, the cryptographic hash function SHA-256 can be used.

At action 404, the artwork is associated with the Genesis address by effecting a single Bitcoin transaction that sends funds to the Genesis address and to the artwork digest address. Bitcoin allows, in a single transaction, one or more input addresses as sources of funds and one or more output addresses as recipients of funds. The artwork digest address is created by processing the digital artwork with a cryptographic hash function and, as such, is unlikely to be a valid Bitcoin address: it was not created by Bitcoin. The funds are sent to the Genesis address and to the artwork digest address from another Bitcoin address that is associated to the creator of the artwork. Subsequent this single transaction that sees funds transferred to the Genesis address and to the artwork digest address, the blockchain will show that funds were transferred, in a single transaction, to the Genesis address and to the digest address, which effectively binds the Genesis address to the artwork digest address and, by extension, the artwork to the Genesis address.

The funds transferred to the Genesis address and to the artwork digest address can be in any amount and need not be the same amount. As the funds transferred to the digest address are effectively lost, the funds transferred to this account can be in the lowest possible amount.

Action 406 confirms ownership of the artwork. It may happen 0, 1, 2, or any number of times in the lifetime of the artwork. If person B wants to confirm that person A owns the artwork, person B can request that person A prove ownership of the artwork by sending funds to its own account (person's A account), which would be recorded in the blockchain and would be publicly available for person B to see. That is, upon request from person B, person A could transfer 0.0001 bitcoin from the public ID of the artwork to the very same public ID of the network and person B would know that the transaction took place by consulting the blockchain. Alternatively, if person B wants to confirm that person A owns the artwork associated with the Bitcoin address, person A could send 0.0001 bitcoins (or any other amount of bitcoins) from the associated Bitcoin address to a Bitcoin address controlled by person B. Person B is now satisfied that person A owns the account. To keep the balance even between person A and person B, person B returns the 0.0001 bitcoins back to the person A's Bitcoin address (account). Any action that can confirm (affirm) ownership of the artwork can be referred to as a confirmation action or as an affirmation action.

Action 408 transfers ownership of the artwork using a Bitcoin protocol over the Bitcoin network. It may happen 0, 1, 2, or any number of times in the lifetime of the artwork. Let us consider person A transferring ownership of an artwork to person B. Therefore, person A controls the Bitcoin address currently associated with the artwork, call it address A, which, is the Genesis address for as long as the ownership of the artwork is not transferred to another address. Person B first creates a new Bitcoin public key (address) and a private key, call it address B. Person B gives address B to person A. Person A then uses Bitcoin's secure transfer mechanism to transfer all Bitcoins from address A to address B. By definition, the owner of address B is the owner of the artwork. Therefore, person B is the owner of the artwork.

The artwork that has associated thereto a Bitcoin address can be displayed on a gallery's website from which the public address of the artwork can be obtained as well as the hash of the digital artwork. For example, the public address and/or the hash of the digital artwork can be displayed alongside the artwork, or on another page of the website, or at a hyperlink displayed on the website, or in any other suitable way.

If desired, once a person has acquired the digital artwork, he can process the digital artwork with the cryptographic hash function (the same one originally used) to ensure that the artwork digest is the same as what is displayed in the blockchain.

In another embodiment, the existing technology and the computing infrastructure of Bitcoin applies to physical artifacts such as paintings, luxury goods, photographs, graphic designs, physical consumer goods, land titles, vehicle registration, etc. This embodiment is similar to the embodiment described in FIG. 3, except the artwork is physical rather than digital. Therefore, inscribing the Bitcoin address may on a physical nature, and has many possibilities. The address may be written in marker on the back of the painting, painted by the artist on the front of the painting below the signature, or put inside an RFID tag that transmits the bitcoin address.

Other embodiments of the present disclosure exist with respect to cryptocurrencies such as Bitcoin. One set of variants relates to a desired protocol for transactions of bitcoins to/from a Bitcoin address (account) associated with an artwork. In some embodiments, it may be required to be able to distinguish between (a) when ownership of an artwork is confirmed, (b) when ownership of an artwork is transferred, and (c) when there are transactions not related to ownership of the artwork.

Such a protocol may simply use Bitcoin itself, or be part of a higher-level protocol in an overall “stack” of transactions that has Bitcoin in a lower level. The protocol may need special software, or it may be just publicly-stated rules. One simple variant may specify that transfer of ownership of the artwork from address A to address B only happens in the transaction when, after the transaction is complete, there are exactly 0 bitcoins left in address A. Another variant may specify that transfer of ownership happens only with transfers having a last digit of ‘1’. Some variants may include transfer fees. The protocol associated with a given artwork might be determined at the same time that the artwork is associated with a Bitcoin address. The protocol could be published, such as in the signature associated with a transaction on that Bitcoin address, on the website of the artist, on the artwork itself, and so forth.

Another set of variants relates to preventing artwork ownership becoming ‘glued’. The problem is as follows. Consider a single Bitcoin address A, associated with artwork A, and a second Bitcoin address B, associated with artwork B. Now consider if person C creates a Bitcoin address C. Person C purchases artwork A and, according to the protocol in this example, is defined as the owner of artwork A when all bitcoin funds are transferred from address A to address C. Similarly, Person C purchases artwork B, and is defined as the owner of artwork B when all bitcoin funds are transferred from address B to address C. The problem is that now there are two artworks associated with address C, and in some variants of the disclosure, future confirmation or transferring of ownership might always keep the artworks together. Fortunately, it is possible to avoid this problem. One variant would have a protocol stating that to transfer ownership from address A to address B, address A must become completely empty (0 bitcoin) and address B must start out completely empty. This would be implemented, for example, in the client software. Due to the nature of the Bitcoin protocol, the amount of funds in any address (account) is completely public. Therefore it is straightforward for person B to verify that address A is completely empty. Another variant would be “first-in-first-out” ownership. That is, when artwork A is the first artwork transferred to address C, and artwork B is the second artwork transferred to address C. Address C (account C) is now associated to two artworks. The owner of account C can create two other accounts D and E and the protocol can state that when all funds are sent from address C to address D, the address D gets ownership of artwork A. Subsequently, address C is given more funds and when all funds are sent from address C to address E, then address E gets ownership of artwork B.

Another variant helps to raise the security further. Consider the problem if an online account associated with a public artwork is hacked. Now, since the hacker controls the online account, the hacker becomes the owner of the artwork. Of course, online services have measures to mitigate such incidents, such as hacked-account recovery mechanisms, captchas, and two-factor authentication. Those measures apply to this disclosure as well. However, this disclosure has variants that provide complementary security: rather than having a single (online service, account at online service) associated with an art piece, there is more than one. That is, there is a set of (online service, ID) tuples ((online service, account at online service) tuples). The owner of the artwork can be defined as the person who has full access to the whole set of tuples. In the event that a single online service of person A gets hacked, then the hacker does not get ownership of the artwork, and person A gets time to recover access to that hacked online service. A further variant of this is to define the owner as the person who owns has access to the majority of a set of (online service, ID) tuples, rather than all. Another variant is for the owner of the set to be able to add new (online service, ID) to the set, or delete (online service, ID) from the set. This variant makes it less important to be able to recover a hacked account.

Another aspect of the present disclosure concerns the type of online service. By “online service” we mean a service which can be accessed via network protocols, for example, Internet protocols such as HTTP (hypertext transfer protocol), using web browsers, mobile apps, or software that runs on PCs, game consoles, laptops, tablets, smart phones, mobile devices, or other. Online services may include web-based email like Gmail™, social media services like Twitter™ (http://www.twitter.com) or Facebook™ (http://www.facebook.com), shopping sites like Amazon™ (http://www.amazon.com), travel sites like Airbnb™ (http://www.airbnb.com), and any other online service where one may have an account/ID intended for a single owner, and there is some measure of security to restrict access to the account/ID. As discussed earlier, online services also include cryptocurrencies like Bitcoin or Litecoin, which has an ID (the Bitcoin address which is the cryptographic public key) and a measure of security that restricts access (the cryptographic private key). In cryptocurrencies like Bitcoin, Litecoin, Dogecoin, or in online services using cryptoprotocols such as NXT, Counterparty and Ethereum, transactions or ownership are secured via a ledger (electronic ledger) that is distributed across a network (for example Bitcoin's Blockchain). Online services also include possible new online services that have a secure ledger to track transactions or ownership of currency or a more general token of ownership; such a ledger can be, but does not need to be public or peer-distributed like Bitcoin's blockchain.

Another set of variants includes changing from electronic to physical storage of Bitcoin private keys, and everything in between. For example, consider person A, who has a physical coin with a Bitcoin address and sealed private key that represent artwork A. Person A could physically break the private key seal, and type the address and private key onto their electronic Bitcoin wallet. Then, person A could transfer ownership of artwork A to another Bitcoin address on the electronic Bitcoin network. In another example, an electronically-stored Bitcoin address and private key may be transferred to a USB-based flash drive, then that flash drive may be stored in a bank vault that is not connected to any networks. In general, all the variants used to keep Bitcoin private keys secure may be applied here. These embodiment applies to digital artwork as well physical objects/artifacts.

This disclosure includes further aspects that are not limited to establishing, affirming, and transferring ownership of only “reproducible artworks”. This disclosure could apply to any item that is easy to reproduce, where there is supposed to be only one true owner, and it is important to establish, affirm, and transfer the ownership of that item. This might include “designs” from designers (e.g. images from graphic designers), stocks, loans, commodities, software licenses, songs, movies, TV shows, and anything else that might have traditionally used digital rights management (DRM) software or had its own copy protection software. In some embodiments of the present disclosure, each copy of a design, stock, etc. gets its own (online service, account at online service). For example, company A could sell a copy of its software to company B by watermarking (the software) the copy with a Bitcoin address, and giving company B the private key. Company A could query ownership from any user of the software by asking the user to send funds from the Bitcoin address associated with that copy of the software; company B would be the only user able to legitimately demonstrate ownership. Company B could transfer ownership to Company C at Bitcoin address C using the Bitcoin network; and via the Blockchain, Company A would know that address C is now the only legitimate user.

This disclosure can also apply to items that are reproducible, less easy to reproduce, but worthwhile to reproduce nonetheless. For example, it may be financially worthwhile if the “fake” copy can be sold at a high enough price. This includes paintings, designer furniture, designer bags, expensive watches, and more.

In the preceding description, for purposes of explanation, numerous details are set forth in order to provide a thorough understanding of the embodiments. However, it will be apparent to one skilled in the art that these specific details are not required. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

1. A method of dealing with a digital artwork, the method comprising:
processing the digital artwork with a cryptographic hash function to obtain an artwork digest, the artwork digest being in a format of a cryptocurrency online service address and constituting an artwork digest address;
generating a public address and a private key of the public address for the cryptocurrency online service; and
effecting, in a single transaction, a transfer of cryptocurrency to the public address and to the artwork digest address, a public electronic ledger to display the single transaction that transferred the cryptocurrency to the public address and to the artwork digest address, the single transaction displayed in the electronic ledger to establish that the public address is associated with the artwork digest.

2. The method of claim 1 further comprising affirming ownership of the digital artwork by performing, from the public address, an affirmation transaction, the electronic ledger to display the affirmation transaction.

3. The method of claim 2 wherein the affirmation transaction includes sending a cryptocurrency amount from the public address to the public address.

4. The method of claim 1 wherein the public address is an original address, the method further comprising transferring ownership of the digital artwork by transferring cryptocurrency from the original public address to a recipient public address.

5. The method of claim 4 wherein transferring cryptocurrency from the original public address to the recipient public address is the first transfer of cryptocurrency from the original public address to any address.

6. The method of claim 4 further comprising transferring ownership of the digital artwork by transferring cryptocurrency from the recipient public address to a subsequent public address.

7. The method of claim 5 wherein transferring cryptocurrency from the original public address to a recipient public address is preceded by generating the recipient public address.

8. The method of claim 7 wherein generating the recipient public address is followed by providing the recipient public address to an owner of the original public address.

9. The method of claim 1 wherein the cryptographic hash function is SHA-256.

10. The method of claim 1 wherein the cryptocurrency is the bitcoin and the electronic ledger is the Bitcoin blockchain.

11. A tangible, non-transitory computer-readable medium having recorded thereon instructions to be carried out by a computer to perform a method of dealing with a digital artwork as claimed in any one of claims 1 to 10.

12. A method of dealing with an artwork, the method comprising:
generating an account at an online service, generating the account including generating a passcode for the account; and
associating, to the artwork, the online service and the account of the online service, the artwork being owned by a keeper of the passcode.

13. The method of claim 12 wherein associating includes marking the artwork with the name of the online service and the account of the online service.

14. The method of claim 13 wherein marking includes inscribing, on the artwork, the name of the online service and the account of the online service.

15. The method of claim 13 wherein marking includes watermarking the artwork with the name of the online service and the account of the online service.

16. The method of claim 12 wherein associating includes:
displaying the artwork; and
displaying, next to the artwork, the name of the online service and the account of the online service.

17. The method of claim 16 wherein the artwork is a digital artwork and displaying the artwork and displaying, next to the artwork, the name of the online service and the account of the online service, is effected through a website.

18. The method of claim 12 wherein associating, to the artwork, an online service and an account of the online service is preceded by opening the account for the online service.

19. The method of claim 12 further comprising accessing the account using the passcode and affirming ownership of the artwork by performing, from within the account, an action that is detectable outside the account.

20. The method of claim 19 wherein:
the online service is an email service and the account is an email account, and
affirming ownership of the artwork includes sending an email from the email account to another email account.

21. The method of claim 19 wherein:
the online service is a cryptocurrency service and the account is a first cryptocurrency service account,
affirming ownership of the artwork includes, in a transaction, sending an amount of cryptocurrency from the first cryptocurrency service account to a second cryptocurrency service account, and
a public electronic ledger records the transaction.

22. The method of claim 19 wherein:
the online service is a cryptocurrency service and the account is a first cryptocurrency service account,
affirming ownership of the artwork includes, in a transaction, sending an amount of cryptocurrency from the first cryptocurrency service account to the first cryptocurrency service account, and
a public electronic ledger records the transaction.

23. The method of claim 19 wherein:
the online service is a blogging service and the account is a blogging service account, and
affirming ownership of the artwork includes posting a blog entry from the blogging service account.

24. The method of claim 12 further comprising transferring ownership of the artwork to a person by providing the passcode to the person.

25. The method of claim 24 further comprising, subsequent the passcode being provided to the person, the person modifying the passcode.

26. A computer-implemented method of dealing with an artwork, the method comprising:
at an online service, generating an account, generating the account including assigning a passcode to the account;
transforming the artwork by marking the artwork with the name of the online service and the account of the online service, the artwork being owned by a keeper of the passcode; and
affirming ownership of the artwork by performing, from within the account, an action that is detectable outside the account.

27. The computer-implemented method of claim 25 further comprising transferring ownership of the artwork to a person by providing the passcode to the person.

28. The method of claim 26 wherein:
the online service is a cryptocurrency service and the account is a first cryptocurrency service account,
affirming ownership of the artwork includes, in a transaction, sending cryptocurrency from the first cryptocurrency service account to a second cryptocurrency service account, and
a public electronic ledger records the transaction.

29. The method of claim 26 wherein:
the online service is a cryptocurrency service and the account is a first cryptocurrency service account,
affirming ownership of the artwork includes, in a transaction, sending cryptocurrency from the first cryptocurrency service account to the first cryptocurrency service account, and
a public electronic ledger records the transaction.

30. The method of claim 26 wherein marking includes inscribing, on the artwork, the name of the online service and the account of the online service.

31. The method of claim 26 wherein marking includes watermarking the artwork with the name of the online service and the account of the online service.

32. The method of claim 26 wherein:
the online service is an email service and the account is an email account, and
affirming ownership of the artwork includes sending an email from the email account to another email account.

33. The method of claim 26 wherein:
the online service is a blogging service and the account is a blogging service account, and
affirming ownership of the artwork includes posting a blog entry from the blogging service account.

34. The method of claim 27 further comprising, subsequent the passcode being provided to the person, the person modifying the passcode.
